(19) United States
(12) Patent Application Publication
(10) Pub. No.: US 2024/0188567 A1
(43) Pub. Date: Jun. 13, 2024

(54) GREEN TIDE CONTROL AGENT CONTAINING HYDROGEN PEROXIDE

(71) Applicant: Hansol Chemical, Wanju-gun (KR)

(72) Inventors: Yongdoo KIM, Wanju-gun (KR); Jaekuk Kim, Wanju-gun (KR); Jiho Shin, Wanju-gun (KR); Hanul Lee, Wanju-gu (KR); Nam Kwon, Wanju-gun (KR); Nuri Oh, Wanju-gun (KR); Jisu Kim, Wanju-gun (KR)

(73) Assignee: Hansol Chemical, Wanju-gun (KR)

(21) Appl. No.: 18/535,613

(22) Filed: Dec. 11, 2023

(30) Foreign Application Priority Data
Dec. 12, 2022 (KR) 10-2022-0172756
Feb. 9, 2023 (KR) 10-2023-0017159

(51) Int. Cl. A01N 59/00; A01N 25/22; A01P 1/00; C02F 1/50

(52) U.S. Cl. CPC A01N 59/00; A01N 25/22; A01P 1/00; C02F 1/50; C02F 2103/007

(57) ABSTRACT

Proposed is a green tide control agent containing hydrogen peroxide, a carboxylic acid compound, a ketone compound, and a flavonoid-based compound.

### CROSS REFERENCE TO RELATED APPLICATION

The present application claims priority to Korean Patent Application No. 10-2022-0172756 filed Dec. 12, 2022 and Korean Patent Application No. 10-2023-0017159 filed Feb. 9, 2023, the entire contents of which are incorporated herein for all purposes by this reference.

### BACKGROUND OF THE DISCLOSURE

### 1. Field of the Disclosure

The present disclosure relates to a green tide control agent containing hydrogen peroxide.

### 2. Description of the Related Art

Green tide is a phenomenon of a change in watercolor to green because cyanobacteria belonging to the genera Microcystis, Annabena, and Apanizomenon grow in large quantities in rivers or lakes. The main cause of the green tide is eutrophication. When fertilizers sprayed on surrounding agricultural lands flow into the rivers or lakes, excessive nutrients are supplied, and when the supplied nutrients offer suitable conditions for cyanobacteria to grow, cyanobacteria proliferate explosively.

Green tide turns the watercolor green, which harms aesthetics. In addition, green tide depletes oxygen in the water, which has serious effects on aquatic life, including most fish.

The conventionally known methods of controlling green tide include: using sterilizing agents such as hypochlorous acid soda; depositing green tide as sediment by using a mixture of unsaturated fatty acids, sodium silicate, and kaolin; and adsorbing green tide by using inorganic ceramics or adsorbing and settling green tide by using copper salt inorganic oxides.

In addition, various green tide control technologies using physical and chemical methods have been developed. Physical methods include: installing an artificial waterfall to induce an artificial destruction of the stratum within the lake and reduce the amount of algae; or using electrolysis to achieve the same effect as pressure flotation with the use of only electrodes without using coagulants or oversaturated water. In electrolysis, a soluble metal such as aluminum is used for the anode to promote agglomeration.

Chemical methods include: administering a chemical coagulant containing aluminum, calcium, and iron. These aluminum, calcium, and iron ions are combined with phosphate ions to form an insoluble precipitate, removing phosphorus dissolved in water, and through this, the green tide can be reduced; and using algaecides which largely contain copper sulfate.

These conventional control methods can control green tide with ease in small waters but not exhibit expected effects in large waters. In addition, most physical methods are unsuitable for controlling green tide while tracking based on a fixed platform, and chemical and biological methods may entail problems such as secondary pollution or ecosystem disturbance relative to the effectiveness. Electrolysis consumes a huge amount of power leading to a significantly low economic feasibility, and chemical coagulants do not remove algae toxicity due to precipitation.

Accordingly, there is a need to develop a green tide control agent that does not worry about residues, is not ecologically toxic to aquatic life, such as fish and water fleas, and can be simply manufactured by tracking green tide.

### DOCUMENTS OF RELATED ART

### Patent Document

(Patent document 0001) Korean Patent No. 10-1827892.

### SUMMARY OF THE DISCLOSURE

The present disclosure is to provide a green tide control agent containing hydrogen peroxide which may simply control green tide with high efficiency.

Additionally, the present invention is to provide a green tide control agent containing hydrogen peroxide. Despite containing hydrogen peroxide, the agent is easy to distribute and store with the hydrogen peroxide at high stability.

The green tide control agent contains hydrogen peroxide, a carboxylic acid compound, a ketone compound, and a flavonoid-based compound.

According to an embodiment of the present disclosure, in the green tide control agent, hydrogen peroxide may be contained at a concentration in a range of 2% to 60% by weight based on the total weight of the agent.

In the green tide control agent, the carboxylic acid compounds may satisfy Formula 1.

R¹—COOH [Formula 1]

In Formula 1, R¹ may be a straight-chain alkyl group having 2 to 10 carbon atoms, a branched-chain or cyclic alkyl group having 3 to 10 carbon atoms, or an alkyl group including an aromatic or hetero-aromatic ring having 5 to 20 carbon atoms.

In the green tide control agent, the ketone compound may satisfy Formula 2.

R²—CO—R³ [Formula 2]

In Formula 2, R² or R³ may be a straight-chain alkyl group having 1 to 6 carbon atoms, a branched-chain or cyclic alkyl group having 3 to 10 carbon atoms, or an alkyl group including an aromatic or hetero-aromatic ring having 5 to 20 carbon atoms.

In the green tide control agent, the carboxylic acid compound may be contained at a concentration in a range of 5 to 500 ppm.

In the green tide control agent, the ketone compound may be contained at a concentration in a range of 5 to 500 ppm.

In the green tide control agent, the flavonoid-based compound may be contained at a concentration in a range of 5 to 500 ppm.

In the green tide control agent, the carboxylic acid compound, ketone compound, and flavonoid-based compound are contained in a weight ratio of 1:0.5 to 1.5:0.5 to 1.5.

The green tide control agent may be used at a concentration in a range of 0.001 to 30 mg per 1 L of a solution to be treated.

The green tide control agent may have stability in a range of 90% or more as measured based on KS M 1112.

The green tide control agent containing hydrogen peroxide can control green tide with high efficiency by containing the hydrogen peroxide, carboxylic acid compound, ketone compound, and flavonoid-based compound, and in the agent, the hydrogen peroxide shows high stability.

### BRIEF DESCRIPTION OF THE DRAWINGS

FIG. 1 shows the results of measuring the amount of microcystin, total organic carbon, and total nitrogen after administration of a green tide control agent according to an example of the present disclosure.

### DESCRIPTION OF THE PREFERRED EMBODIMENTS

The advantages and features of examples of the present disclosure and the method of achieving the advantages and features will be clear with reference to the examples described in detail below along with the accompanying drawings. However, the present disclosure is not limited to the examples disclosed below and may be implemented in various forms. The examples are merely provided to ensure that the disclosure of the present disclosure is complete as well as to have those skilled in the art fully informed of the scope of the disclosure. The disclosure is only defined by the scope of the claims. Like reference numerals refer to like elements throughout the specification.

In describing the examples of the present disclosure, if it is determined that a detailed description of a known function or configuration may unnecessarily obscure the gist of the present disclosure, the detailed description will be omitted. The terms described below are terms defined in consideration of functions in the examples of the present disclosure and may vary depending on the intention or custom of the user or operator. Therefore, the definition should be made based on the contents throughout this specification.

The green tide control agent according to the present disclosure contains hydrogen peroxide, a carboxylic acid compound, a ketone compound, and a flavonoid-based compound.

The green tide control agent contains all of the carboxylic acid compound, ketone compound, and flavonoid-based compound along with hydrogen peroxide so that the agent may significantly improve the stability of hydrogen peroxide and also enhance a controlling effect on the green tide.

In the green tide control agent, hydrogen peroxide may be contained at a concentration in a range of 2% to 60% by weight based on the total weight of the agent, preferably 2% to 30% by weight, more preferably 2.5% to 10% by weight, and most preferably 3% to 7% by weight. When the concentration of hydrogen peroxide is high, ecotoxicity may appear due to the locally high concentration of hydrogen peroxide before the agent is uniformly mixed with a solution to be treated.

The carboxylic acid compound may satisfy Formula 1.

R¹—COOH [Formula 1]

In Formula 1, R¹ may be a straight-chain alkyl group having 2 to 10 carbon atoms, a branched-chain or cyclic alkyl group having 3 to 10 carbon atoms, or an alkyl group including an aromatic or hetero-aromatic ring having 5 to 20 carbon atoms.

Preferably, in Formula 1, R¹ may be a straight-chain alkyl group having 3 to 9 carbon atoms, a branched-chain or cyclic alkyl group having 4 to 10 carbon atoms, or an alkyl group including an aromatic or hetero-aromatic ring having 5 to 15 carbon atoms, more preferably a straight-chain or branched chain alkyl group having 5 to 9 carbon atoms.

By using carboxylic acid compound satisfying Formula 1, the stabilization efficiency of hydrogen peroxide is high, and the ecotoxicity of the agent is low.

In the green tide control agent, the carboxylic acid compound may be contained at a concentration in a range of 5 to 500 ppm, preferably 5 to 200 ppm, more preferably 5 to 100 ppm, and most preferably 10 to 80 ppm. When a small amount of carboxylic acid compound is contained, the stability of hydrogen peroxide may be lowered, and when a large amount of carboxylic acid compound is contained, there is a risk of ecotoxicity.

The ketone compounds may satisfy Formula 2.

R²—CO—R³ [Formula 2]

In Formula 2, R² or R³ may be a straight-chain alkyl group having 1 to 6 carbon atoms, a branched-chain or cyclic alkyl group having 3 to 10 carbon atoms, or an alkyl group including an aromatic or hetero-aromatic ring having 5 to 20 carbon atoms.

Preferably, R² may have an aromatic or hetero-aromatic ring having 5 to 10 carbon atoms, and R³ may be a straight-chain or branched-chain alkyl group having 1 to 5 carbon atoms. More preferably, R² may be an alkyl group including an aromatic ring having 5 to 8 carbon atoms, and R³ may be a straight-chain or branched-chain alkyl group having 1 to 3 carbon atoms.

In the green tide control agent, the ketone compound may be contained at a concentration in a range of 5 to 500 ppm, preferably 5 to 200 ppm, more preferably 5 to 100 ppm, and most preferably 10 to 80 ppm. When a small amount of ketone compound is contained, the stability of hydrogen peroxide may decrease, and when a large amount of ketone compound is contained, there is a risk of ecotoxicity. The flavonoid-based compound are mixed with carboxylic acid compounds and ketone compounds as described above so that the agent can control green tide with high efficiency due to the synergistic effect of mixing the three compounds.

The flavonoid compound may preferably be a flavone, and more specifically may include one or two or more selected from apigenin, luteolin, baicalein, and chrysin. By using these flavones, a more excellent controlling effect on the green tide may be achieved.

In the green tide control agent, flavonoid-based compound may be contained at a concentration in a range of 5 to 500 ppm, preferably 5 to 200 ppm, more preferably 5 to 100 ppm, and most preferably 10 to 80 ppm. When a small or large amount of flavonoid-based compound is contained, it may be difficult to achieve a synergistic effect by mixing the carboxylic acid compound and the flavonoid-based compound.

In the green tide control agent, the carboxylic acid compound, ketone compound, and flavonoid-based compound may be contained in a weight ratio of 1:0.5 to 1.5:0.5 to 1.5, preferably 1:0.8 to 1.2:0.8 to 1.2. By satisfying this range, the stability of hydrogen peroxide contained in the green tide control agent may be in the range of 90% or more, preferably 93% or more. At this time, the stability may be measured based on KS M 1112.

In the case of removing green tide contained in the solution to be treated by using the green tide control agent, the agent may be administered at a concentration in a range of 0.001 to 30 mg per 1 L of a solution to be treated, preferably in the range of 0.01 to 25 mg, more preferably in the range of 2 to 20 mg, and most preferably in the range of 3 to 15 mg. By satisfying this range, as of Day 10 after administration of the agent, removing microcystin which is a representative toxic substance produced by green tide may be achieved at 95% or more, preferably 97% or more, and even better, 99% or more. In addition, the agent is not toxic to water fleas, bacteria, and fish. Due to the advantages, green tide generated in rivers or lakes may be efficiently controlled by a simple method of spraying the green tide control agent, and the effect on aquatic life other than green algae may be minimized.

Hereinafter, the present disclosure will be described in detail by examples and comparative examples. The following examples are only intended to aid understanding of the present disclosure, and the scope of the present disclosure is not limited by the examples described below.

### EXAMPLE

Caprylic acid was used as a carboxylic acid compound, acetophenone was used as a ketone compound, and chrysin was used as a flavonoid-based compound. The three substances (Caprylic acid, acetophenone, and chrysin) were uniformly mixed in a weight ratio of 1:1:1 to prepare an additive mixture.

Hydrogen peroxide was added to distilled water so that the content of the hydrogen peroxide was 5% by weight based on the total weight of the made solution, and the prepared additive mixture was added to the solution to a concentration of 70 ppm, ultimately preparing a green tide control agent.

### Comparative Examples 1 to 3

A green tide control agent was prepared in the same manner as in the Example, but instead of the additive mixture, each of caprylic acid (Comparative Example 1), acetophenone (Comparative Example 2), and chrysin (Comparative Example 3) was added alone to a concentration of 70 ppm to prepare the agent.

### Comparative Example 4

Hydrogen peroxide was mixed with distilled water to make a solution with 5% by weight of hydrogen peroxide based on the total weight, and the solution was used as a green tide control agent.

### Confirmation of Algae Cell Count

An algae cell count test was performed by using the green tide control agents according to Examples and Comparative Examples, and the results are shown in Table 2. At this time, the test species was Microcystis aeruginosa, and the experiment was performed by using the algae removal efficiency evaluation method in Annex 1 of Ministry of Environment Regulation No. 697, “Algae removal efficiency and ecotoxicity evaluation method”.

### Confirmation of Stability of Hydrogen Peroxide

The stability of hydrogen peroxide contained in the green tide control agents according to Examples and Comparative Examples was measured, and the results are shown in Table 2. At this time, the stability of hydrogen peroxide was measured based on KS M 1112.

### Confirmation of Growth Inhibition Rate

The growth inhibition rates of the green tide control agents according to Examples and Comparative Examples were confirmed under the conditions in Table 1, and the results are shown in Table 2. Specifically, 7 mg of the agents prepared in Examples and Comparative Examples was administered per 1 L of a solution to be treated, and the microcystin cell concentration of each sample was compared immediately after treatment and after 72 hours, and based on the results, the growth inhibition rate was calculated.

Specifically, the calculation was carried out based on the following expression: (growth inhibition rate)=100−(average specific growth rate). At this time, the average specific growth rate may be calculated as follows.

(average specific growth rate)=(ln Xj−ln Xi)/(tj−ti)

Xj is the biomass at time j, and Xi is the biomass at time i.

TABLE 1

| | H₂O₂ | | Product input |
|---|---|---|---|
| | (% by | Additives | amount |
| Division | weight) | (ppm) | (mg/L) |
| Control group | — | — | — |
| (no agent added) | | | |
| Hydrogen peroxide | 5 | — | 7 |
| Caprylic acid | | 70 | |
| Acetophenone | | 70 | |
| Chrysin | | 70 | |
| Additive mixture | | 70 | |

TABLE 2

| | | | Growth | |
|---|---|---|---|---|
| | Cell count (cells/mL) | | inhibition | H₂O₂ |
| Division | 0 day | 3 days | rate (%) | Stability (%) |
| Control group | 102,400 | 926,000 | 0 | — |
| (no agent added) | | | | |
| Hydrogen peroxide | 102,600 | 902,000 | 1.3 | 60-70 |
| Caprylic acid | 102,400 | 329,000 | 47.0 | 80-90 |
| Acetophenone | 102,400 | 773,000 | 8.2 | 80-90 |
| Chrysin | 102,600 | 834,000 | 4.8 | 70-80 |
| Additive mixture | 102,400 | 5,200 | 100 | 95-98 |

### Ecotoxicity Assessment

10 mg of the green tide control agent prepared in Example was administered per 1 L of a solution to be treated. Then, the ecotoxicity was evaluated after 24, 48, and 72 hours of administration, respectively, and the results are shown in Table 3.

Specifically, in Table 3 below, evaluation item A shows the results of the ecotoxicity evaluation of the algae removal material itself, E(L)C50 means a median effective concentration or lethal concentration 50%, and NOEC means a NO observed effect concentration. Referring to Table 3, the EC50 or LC50 was all above 25 mg/L, and the NOEC was 10 mg/L for the lowest luminescent bacteria.

Referring to the experimental results in Table 2 and the results in Table 3, the green tide control agent of Example had a high green algae removal efficiency compared to Comparative Example 4 even if the sample of Example contained the same amount of hydrogen peroxide. Furthermore, in the case of achieving the same effect as in Example by using the green tide control agent containing only hydrogen peroxide shown in Table 4, it was obvious that a large amount of green tide control agent must be administered. However, referring to the results in Table 3, when a large amount of green tide control agent containing hydrogen peroxide was added, a high possibility of toxicity, especially to luminescent bacteria was confirmed, and based on this point, the green tide control agent according to Example of the present disclosure was confirmed to overcome limitations of ecotoxicity driven by conventional hydrogen peroxide as well as to control green tide with high efficiency.

Evaluation item B is an evaluation of ecotoxicity after administration of the algae removal material, and TU means Toxic Unit. Referring to Table 3, when administered at 10 mg or less per 1 L of a solution to be treated, the material was confirmed not to be toxic to water fleas, luminescent bacteria, and fish.

TABLE 3

| Evalu- | Concen- | Reac- | Ecotoxicity | | |
|---|---|---|---|---|---|
| ation | tration | tion | Water | Luminescent | Fish |
| items | of use | time | flea | bacteria | (D. rerio) |
| A | — | — | E(L)C50 = | E(L)C50 = | E(L)C50 |
| | | | 68.8 mg/L, | 29.4 mg/L, | 213.8 mg/L, |
| | | | NOEC = | NOEC = | NOEC = |
| | | | 25 mg/L | 10 mg/L | 100 mg/L |
| B | 10 mg/L | 24 hrs | TU = 0 | TUB = 0 | TU = 0 |
| | | 48 hrs | | | |
| | | 72 hrs | | | |

### Confirmation of Microcystin Inhibition Effect and Water Pollution

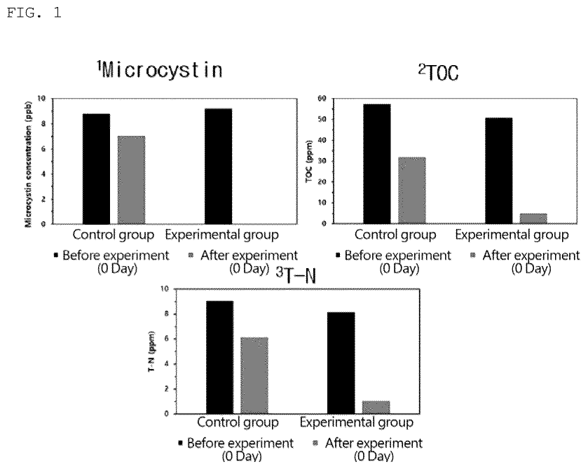

An experiment was conducted with the mesocosm system at Iksan Wanggung Reservoir. A control group with no treatment of the agent and 10 mg of green tide control agent per 1 L of water to be treated were administered, and then microcystin concentration, total organic carbon (TOC), and total nitrogen (T-N) amount were measured and compared at Day 0 and 10. The comparison results are shown in FIG. 1. At this time, the microcystin concentration was measured using the Eurofins-Technologies ELISA Test, the total organic carbon value was measured by using the high-temperature combustion oxidation method, and the total nitrogen value was measured by using the ultraviolet ray-visible spectroscopic oxidation method.

Referring to FIG. 1, on Day 10 after the administration of the agent according to Example, the microcystin concentration was lowered by 99.4% from 9.2 ppb to 0.1 ppb, the total organic carbon value was lowered by 90.4% from 50.9 ppm to 4.9 ppm, and the total nitrogen value was lowered by 87.2% from 8.2 ppm to 1.0 ppm. On the other hand, no significant reduction was observed in the control group with no treatment.

Based on this, the green tide control agent according to Example of the present disclosure was confirmed to remove blue-green algae among algae cells with high efficiency. Also confirmed was that the agent removed microcystin which is a toxic substance of blue-green algae, so the concentration of microcystin decreased sharply on Day 10 after administration of the agent. In addition, by applying the agent, the total organic carbon value and total nitrogen value were also confirmed to be lowered in a significant way.

What is claimed is:

1. A green tide control agent comprising hydrogen peroxide, a carboxylic acid compound, a ketone compound, and a flavonoid-based compound.

2. The green tide control agent of claim 1, wherein the hydrogen peroxide is contained at a concentration in a range of 2% to 60% by weight based on the total weight of the agent.

3. The green tide control agent of claim 1, wherein the carboxylic acid compound satisfies Formula 1:
R¹—COOH [Formula 1]
(in Formula 1, R¹ is a straight chain alkyl group having 2 to 10 carbon atoms, a branched-chain or cyclic alkyl group having 3 to 10 carbon atoms, or an alkyl group comprising an aromatic or hetero-aromatic ring having 5 to 20 carbon atoms).

4. The green tide control agent of claim 1, wherein the ketone compound satisfies Formula 2:
R²—CO—R³ [Formula 2]
(in Formula 2, R² or R³ is a straight-chain alkyl group having 1 to 6 carbon atoms, a branched-chain or cyclic alkyl group having 3 to 10 carbon atoms, or an alkyl group containing an aromatic or hetero-aromatic ring having 5 to 20 carbon atoms).

5. The green tide control agent of claim 1, wherein the carboxylic acid compound is contained at a concentration in a range of 5 to 500 ppm.

6. The green tide control agent of claim 1, wherein the ketone compound is contained at a concentration in a range of 5 to 500 ppm.

7. The green tide control agent of claim 1, wherein the flavonoid-based compound is contained at a concentration in a range of 5 to 500 ppm.

8. The green tide control agent of claim 1, wherein the carboxylic acid compound, the ketone compound, and the flavonoid-based compound are contained in a weight ratio of 1:0.5 to 1.5:0.5 to 1.5.

9. The green tide control agent of claim 1, wherein the green tide control agent is used in an amount of 0.001 to 30 mg per 1 L of a solution to be treated.

10. The green tide control agent of claim 1, wherein the green tide control agent has a stability of 90% or more as measured based on KS M 1112.

11. A method for controlling green tide, the method comprising:
administering the green tide control agent according to claim 1 to water in need thereof.
